(19) United States
(12) Patent Application Publication
(10) Pub. No.: US 2026/0067300 A1
(43) Pub. Date: Mar. 5, 2026

(54) GATEWAY INCLUDING AN INTRUSION DETECTION SYSTEM IN A CONTROLLER AREA NETWORK OF A VEHICLE AND A METHOD OF OPERATING THE SAME

(71) Applicants: HYUNDAI MOTOR COMPANY, Seoul (KR); KIA CORPORATION, Seoul (KR)

(72) Inventor: Dong Woo Kang, Hwaseong-si (KR)

(73) Assignees: HYUNDAI MOTOR COMPANY, Seoul (KR); KIA CORPORATION, Seoul (KR)

(21) Appl. No.: 19/233,970

(22) Filed: Jun. 10, 2025

(30) Foreign Application Priority Data
Aug. 30, 2024 (KR) 10-2024-0117472

(51) Int. Cl. H04L 9/40

(52) U.S. Cl. CPC H04L 63/1416

(57) ABSTRACT

A method of operating an apparatus including an intrusion detection system in a controller area network (CAN) of a vehicle includes receiving CAN messages transmitted through the CAN for a determined time, determining a processor load rate of one or more processors of the apparatus while receiving the CAN messages, comparing the processor load rate with a processor load rate threshold value of an attack detection algorithm, and performing the attack detection algorithm based on determining that the processor load rate threshold value of the attack detection algorithm is greater than the identified load rate of the processor. The determined time may be a time required for receiving a predetermined number of messages having a shortest message period among multiple message periods supported by the CAN.

### CROSS-REFERENCE TO RELATED APPLICATION

This application claims the benefit of and priority to Korean Patent Application No. 10-2024-0117472, filed on Aug. 30, 2024, the entire contents of which are hereby incorporated herein by reference.

### BACKGROUND

### 1. Technical Field

The present disclosure relates to an apparatus (e.g., a gateway) including an intrusion detection system in a controller area network (CAN) of a vehicle and a method of operating the same.

### 2. Discussion of Related Art

As various functions are installed on a vehicle and many electronic devices are connected to the vehicle, various communication networks are included in the vehicle. Representative technologies of vehicle communication networks include a controller area network (CAN), a local interconnect network (LIN), FlexRay, media oriented system transport (MOST), a vehicle Ethernet, etc. Among these, CAN communication may be generally used to communicate between electronic control units (or devices) in a vehicle. For example, the electronic control units may form a single network using CAN communication to transmit and receive sensor information or control commands. According to the CAN communication, since devices that perform CAN communication may communicate with each other, and multiple modules may be controlled, using a single CAN interface, the number of connection lines, the weight of the vehicle, and a cost may be reduced. Thus, CAN communication is recognized as a very efficient communication method.

However, as many functions of the vehicle are electronically controlled, the threat of vehicle cyberattacks has also increased. To respond to such threat, intrusion detection systems are being developed to detect the presence or absence of intrusion by monitoring CAN communication traffic and analyzing the CAN communication traffic. Although technologies for various intrusion detection systems have been proposed, there is a problem in applying algorithms that are complicated or have lots of calculations to all vehicles in the same manner. For example, in the case of an attack that transmits many messages within a short time, such as a denial of service (DOS) attack, vehicles with high specifications may have no problem in performing the corresponding attack detection algorithm, but vehicles with lower specifications may take a long time to perform an attack detection algorithm or may be unable to perform the attack detection algorithm properly, thereby causing problems such as the degradation of the function or stop of operation of the electronic control device.

### SUMMARY

Embodiments of the present disclosure provide a method of preventing event storming (or message reception, message collection, etc.) according to a load rate of a processor, and an apparatus (e.g., a gateway) including an intrusion detection system that performs the method.

Other embodiments of the present disclosure provide an apparatus (e.g., a gateway) including an intrusion detection system that operates in consideration of specifications, a state, and/or an environment of a vehicle, and a method of operating the same.

Other embodiments of the present disclosure provide an apparatus (e.g., a gateway) including an intrusion detection system that performs an attack detection algorithm in consideration of a load rate of a processor, and a method of operating the same.

According to an embodiment, a method of operating a gateway including an intrusion detection system in a controller area network (CAN) of a vehicle is provided. The method includes receiving CAN messages transmitted through the CAN for a determined time. The determined time is a time required for receiving a predetermined number of messages having a shortest message period among multiple message periods supported by the CAN. The method also includes determining a processor load rate of one or more processors while receiving the CAN message. The method further includes comparing the processor load rate with a processor load rate threshold value of an attack detection algorithm. The method additionally includes performing the attack detection algorithm based on determining that the processor load rate threshold value of the attack detection algorithm is greater than the processor load rate.

The one or more processors may include a plurality of processors, and the processor load rate may be an average of load rates of the plurality of processors.

The processor load rate threshold value may be determined based on at least one of a function, specifications, a driving state, or a communication environment of the vehicle.

The processor load rate threshold value may be determined as a fraction of

$${\sum }_{n = 1}^{m} {l}_{n} ,$$

where n denotes a processor index, m denotes the number of processors, and l denotes an average load rate of the processor measured for a certain amount of time.

The processor load rate threshold value may be obtained by measuring an average load rate of the one or more processors in consideration of at least one of a driving state of the vehicle and a communication environment of the vehicle including the gateway.

The method may further include not performing the attack detection algorithm based on determining that the processor load rate is greater than or equal to the processor load rate threshold value of the attack detection algorithm.

According to another embodiment, an apparatus including an intrusion detection system in a controller area network (CAN) of a vehicle is provided. The apparatus includes a storage unit, a communication unit configured to support CAN communication, and one or more processors. The one or more processors are configured to receive CAN messages transmitted through the CAN for a determined time. The determined time is a time required for receiving a predetermined number of messages having a shortest message period among multiple message periods supported by the CAN. The one or more processors are also configured to determine a processor load rate of the one or more processors while receiving the CAN messages. The one or more processors are further configured to compare the processor load rate with a processor load rate threshold value of an attack detection algorithm. The one or more processors are configured to perform the attack detection algorithm based on determining that the processor load rate threshold value of the attack detection algorithm is greater than the processor load rate.

The one or more processors may include a plurality of processors, and the processor load rate may be an average of load rates of the plurality of processors.

The processor load rate threshold value may be determined based on at least one of a function, specifications, a driving state, or a communication environment of the vehicle.

The processor load rate threshold value may be determined as a fraction of

$${\sum }_{n = 1}^{m} {l}_{n} ,$$

where n denotes a processor index, m denotes a number of processors, and l denotes an average load rate of the processor measured for a certain amount of time.

The processor load rate threshold value may be obtained by measuring an average load rate of the processor in consideration of at least one of a driving state of the vehicle or a communication environment of the vehicle.

The one or more processors may be configured to not perform the attack detection algorithm based on determining that the processor load rate is greater than or equal to the processor load rate threshold value of the attack detection algorithm.

### BRIEF DESCRIPTION OF THE DRAWINGS

The above and other objects, features, and advantages of the present disclosure should become more apparent to those of ordinary skill in the art from the following detailed description take in conjunction with the accompanying drawings, in which:

FIGS. 1A-B are diagrams illustrating various examples in which an intrusion detection system may be disposed in a controller area network (CAN) in a vehicle;

FIG. 2 is a block diagram of the intrusion detection system according to one embodiment of the present disclosure; and

FIG. 3 is a flowchart illustrating operations of the intrusion detection system according to one embodiment of the present disclosure.

### DETAILED DESCRIPTION

Hereinafter, embodiments of the present disclosure are described in detail with reference to the accompanying drawings. However, the technical spirit of the present disclosure is not limited to the described embodiments. Rather, the present disclosure may be implemented in various different forms, and one or more of the components among the descried embodiments may be used by being selectively coupled or substituted without departing from the scope and the technical spirit of the present disclosure.

In addition, terms (including technical and scientific terms) used in embodiments of the present disclosure may be construed as meaning that may be generally understood by those having ordinary skill in the art to which the present disclosure pertains unless explicitly specifically defined and described herein. The meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the present disclosure. When described as “at least one (or one or more) of A, B, or C,” one or more among all possible combinations of A, B, and C may be included.

In addition, terms such as first, second, A, B, (a), and (b) may be used to describe components of the embodiments of the present disclosure. These terms are only for the purpose of distinguishing one component from another component, and the nature, sequence, order, or the like of the corresponding components is not limited by these terms.

In addition, when a first component is described as being “connected,” “coupled,” or “joined” to a second component, this may include a case in which the first component is directly connected, coupled, or joined to the second component, but also a case in which the first component is “connected,” “coupled,” or “joined” to the second component by one or more other components present between the first component and the second component.

In addition, when a certain component is described as being formed or disposed “on (above)” or “below (under)” another component, the terms “on (above)” or “below (under)” may include not only a case in which two components are in direct contact with each other, but also a case in which one or more other components are formed or disposed between the two components. In addition, when described as “on (above) or below (under),” this may include the meaning of not only an upward direction but also a downward direction based on one component.

When a controller, module, component, device, element, or the like of the present disclosure is described as having a purpose or performing an operation, function, or the like, the controller, module, component, device, element, or the like should be considered herein as being “configured to” meet that purpose or to perform that operation or function.

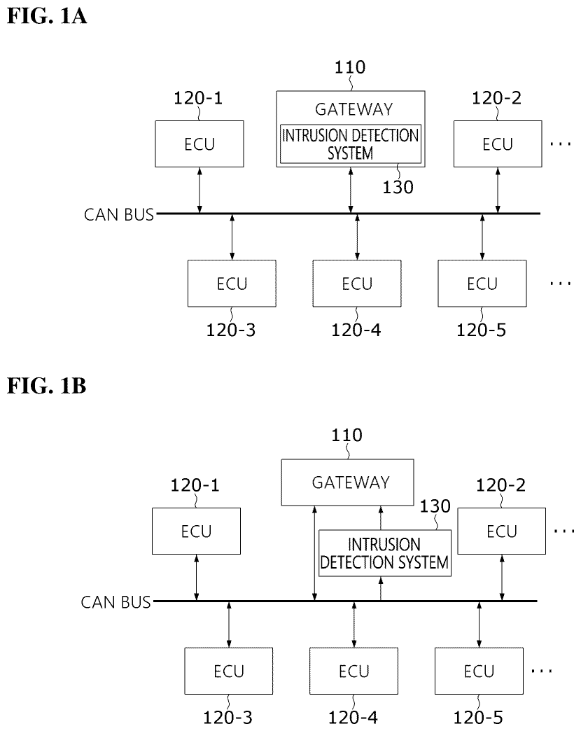

FIGS. 1A-B are diagrams illustrating various examples in which an intrusion detection system may be disposed in a controller area network (CAN) in a vehicle, according to embodiments.

Referring to FIGS. 1A-B, electric control units (ECUs) 120-1, 120-2, 120-3, 120-4, and 120-5, a gateway 110, and an intrusion detection system (IDS) 130 may be connected to a CAN. The gateway 110 is a CAN domain gateway and may connect an electronic control device that performs communication using the CAN to another network. According to various embodiments, the intrusion detection system 130 may be connected to the CAN as a separate device or may be provided as a part of the gateway 110 connected to the CAN.

Specifically, FIG. 1A illustrates an example in which the intrusion detection system 130 is provided as a part of the gateway 110, and FIG. 1B illustrates an example in which the intrusion detection system 130 is formed separately and connected to the gateway 110. According to FIGS. 1A-B, the gateway 110 and the ECUs 120-1, 120-2, 120-3, 120-4, and 120-5 may transmit CAN messages using a CAN bus, and the intrusion detection system 130 may receive the CAN messages transmitted by the gateway 110 and the ECUs 120-1, 120-2, 120-3, 120-4, and 120-5 using the CAN bus. The intrusion detection system 130 may apply an attack detection algorithm to the received CAN messages to determine whether an attack occurs.

Hereinafter, a gateway including the intrusion detection system and an operation thereof, according to embodiments of the present disclosure, are described in more detail.

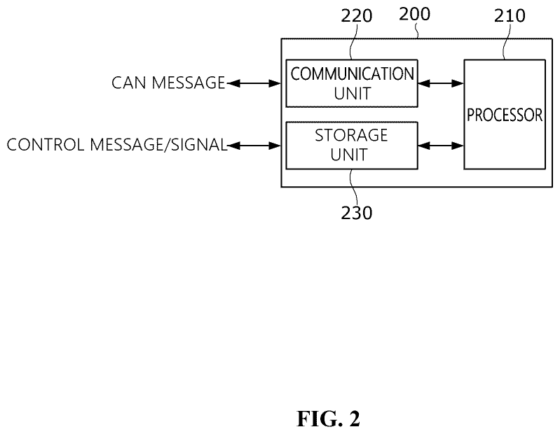

FIG. 2 is a block diagram of a gateway according to an embodiment of the present disclosure.

Referring to FIG. 2, a gateway 200 may include a processor 210, a communication unit 220, and a storage unit 230. According to an embodiment, the processor 210 may be provided as a plurality of processors.

The processor 210 may be a component referred to as a central processing unit (CPU). The processor 210 may include one or more cores. The core may read and process program commands, and the plurality of cores may independently read and process the program commands. In an embodiment, each of the processor 210, the CPU, and the core is a component capable of independently reading and processing program commands and is referred to as the processor 210 for the sake of convenience of description below.

According to an embodiment, the processor 210 may receive the CAN messages through the communication unit 220. The CAN message may be a message transmitted and received through a CAN (or a CAN bus).

According to an embodiment, the processor 210 may determine (e.g., identify) a load rate of the processor (sometimes referred to herein as a “processor load rate”) while receiving the CAN messages. For example, the processor 210 may receive the CAN messages for a determined time and may then determine the processor load rate. The determined time may be set as a time required to receive a predetermined number of messages having the shortest message period (or fastest message cycle) among multiple message periods supported by the CAN. A message period (or cycle) may refer to a time interval between consecutive transmissions of a message in the CAN or a frequency of transmission of the message in the CAN. Thus, for example, a message having a shortest message period may be a type of message with a shortest time interval between consecutive transmissions of the message in the CAN.

As another example, the determined time may be set to a certain amount of time, such as 1000 milliseconds (MS), for convenience. As yet another example, the determined time may be set differently based on an operating state (e.g., driving or stopping) of the vehicle, a communication environment of the vehicle, or specifications of the vehicle.

According to an embodiment, when a plurality of processors 210 are present, the load rate of the processor may be an average of the load rates of the plurality of processors 210. As another example, the load rate of the processor may be the highest load rate among the load rates of the plurality of processors 210. As yet another example, the load rate of the processor may be the lowest load rate among the load rates of the plurality of processors 210.

According to an embodiment, the processor 210 may compare the identified load rate of the processor with a processor load rate threshold value used for performing an attack detection algorithm. The processor load rate threshold value used for performing the attack detection algorithm (hereinafter referred to as the “processor load rate threshold value”) may be calculated according to a predetermined formula. In an embodiment, the processor load rate threshold value may be determined as a fraction (e.g., ¼) of an average load of the processor 210 measured for a certain amount of time, such as 1000 Ms. In an embodiment, the processor load rate threshold value may be determined by Equation 1.

$$\frac{1}{4} {\sum }_{n = 1}^{m} {l}_{n} , \qquad [ Equation 1 ]$$

where n denotes an index of the processor, m denotes the number of processors, and l denotes the average load rate of the processor measured for a certain amount of time, such as 1000 ms. According to Equation 1, the processor load rate threshold value may be determined based on the number of processors in addition to the load rate of the processor.

In some embodiments, the processor load rate threshold value used for performing the attack detection algorithm may vary depending on the operating state of the vehicle, the communication environment of the vehicle, etc. For example, since high-end vehicles may include more processors than low-end vehicles, the processor load rate threshold value used for performing the attack detection algorithm may vary depending on the number of processors included in the vehicle. In addition, even for vehicles with the same specifications, since vehicles equipped with a relatively greater number of functions may have the amount of data to be processed by the processor that differs from that of vehicles equipped with relatively fewer functions, the processor load rate threshold value used for performing the attack detection algorithm may vary based on the number of functions performed in the vehicle.

In some embodiments, the processor load rate threshold value may be calculated in advance and stored in a memory.

According to an embodiment, the processor 210 may perform the attack detection algorithm when the determined processor load rate is lower than the processor load rate threshold value used for performing the attack detection algorithm, and otherwise, the processor 210 may not perform the attack detection algorithm. For example, the processor 210 does not perform the attack detection algorithm when the determined processor load rate is higher than the processor load rate threshold value used for performing the attack detection algorithm. However, the processor 210 may continue performing other functions as a gateway.

The communication unit 220 may support CAN communication. The gateway 200 may communicate with the CAN through the communication unit 220. The communication unit 220 may transmit or receive the CAN messages under the control of the processor 210. The communication unit 220 may also transmit or receive a control message or signal. For example, the control message or signal may be a message or signal for the intrusion detection system to identify the load rate of the processor of the gateway when the gateway and the intrusion detection system are formed separately.

The storage unit 230 may store necessary data and/or programs. The necessary data may be, for example, a formula for calculating the processor load rate threshold value, information for calculating the processor load rate threshold value, one or more attack detection algorithms, information on the gateway 200, etc.

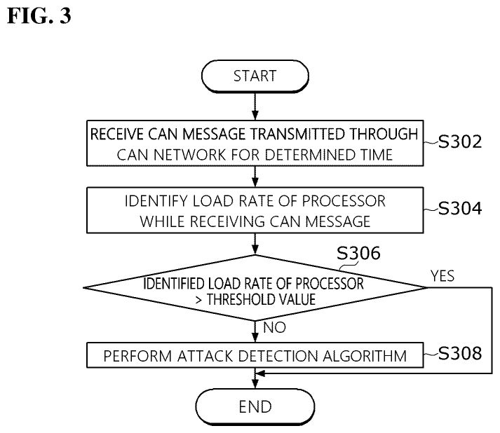

FIG. 3 is a flowchart illustrating operations of the gateway including the intrusion detection system, according to an embodiment of the present disclosure.

Referring to FIG. 3, in an operation S302, the gateway may receive CAN messages transmitted through a CAN for a determined time. The determined time may be set as a time required to receive a predetermined number of messages having the shortest message period among multiple message periods supported by the CAN. As another example, the determined time may be set to a certain amount of time, such as 1000 ms. In some embodiments, the determined time may be set differently depending on an operating state (e.g., driving or stopping) of the vehicle, a communication environment of the vehicle, and/or specifications of the vehicle. The gateway may receive all CAN messages transmitted through the CAN for the determined time.

In an operation S304, the gateway may determine (e.g., identify) a load rate of a processor in the gateway while receiving the CAN messages. According to an embodiment, when the gateway includes a plurality of processors, the load rate of the processor may be an average of load rates of the plurality of processors. As another example, the load rate of the processor may be the highest load rate among the load rates of the plurality of processors. As yet another example, the load rate of the processor may be the lowest load rate among the load rates of the plurality of processors.

In an operation S306, the gateway may determine whether the determined load rate of the processor is greater than a processor load rate threshold value of an attack detection algorithm. According to an embodiment, the processor load rate threshold value used for performing the attack detection algorithm (the “processor load rate threshold value”) may be calculated in advance and stored in a memory. According to another embodiment, the processor load rate threshold value used for performing the attack detection algorithm may be calculated according to a predetermined formula. For example, the processor load rate threshold value may be determined by Equation 2.

$$\frac{1}{4} {\sum }_{n = 1}^{m} {l}_{n} , \qquad [ Equation 2 ]$$

where n denotes an index of the processor, m denotes the number of processors, and l denotes the average load rate of the processor measured for a certain amount of time, such as 1000 ms. According to Equation 2, the processor load rate threshold value may be determined based on the number of processors in addition to the load rate of the processor.

According to an embodiment, the processor load rate threshold value may vary depending on at least one of a function, specifications, a driving state, or a communication environment of the vehicle. For example, even for vehicles with the same specification, since the amount of data to be processed may vary depending on the driving state, the processor load rate threshold value used for performing the attack detection algorithm may be different for different driving states. In addition, even for the vehicles with the same specification, since executable functions may be different, the processor load rate threshold value used for performing the attack detection algorithm may be different for vehicles with different executable functions. In addition, even when the same function is performed, since a data processing speed, etc. may be different depending on the specifications of the vehicle, the processor load rate threshold value used for performing the attack detection algorithm may be different for different vehicle specifications.

In an operation S308, the gateway may perform the attack detection algorithm based on determining that the processor load rate threshold value of the attack detection algorithm is greater than the identified load rate of the processor. In an embodiment, when the identified load rate of the processor of the gateway is lower than the processor load rate threshold value of the attack detection algorithm, it may be determined that the gateway has a resource capable of performing the attack detection algorithm while operating as a gateway.

However, when the identified load rate of the processor of the gateway is equal to or higher than the processor load rate threshold value of the attack detection algorithm, it may be determined that the gateway has an insufficient resource to perform the attack detection algorithm, and the gateway may perform only the function as a gateway. Accordingly, the gateway may not perform the attack detection algorithm when the processor load rate threshold value of the attack detection algorithm is not greater than the identified load rate of the processor. According to an embodiment, the gateway may receive and process the CAN messages even when not performing the attack detection algorithm.

According to an embodiment, even when the same attack detection algorithm is installed on various types of vehicles, whether it is executed may vary depending on the specifications, driving state, communication environment, etc., of the vehicle.

According to an embodiment, the gateway may select an attack detection algorithm to be applied in consideration of the identified load rate of the processor. For example, the gateway may select at least one of the attack detection algorithms in which the processor load rate threshold value is higher than the identified load rate of the processor in consideration of the determined load rate of the processor among the plurality of attack detection algorithms stored in the storage unit.

According to an embodiment, when it is determined that the gateway performs or does not performs the attack detection algorithm, the gateway may re-perform the operation from the beginning.

An example of the gateway including the intrusion detection system has been described above. Hower, the present disclosure is not limited thereto and the intrusion detection system may be included in a suitable apparatus other than a gateway, in some embodiments. For example, an electronic control device including the intrusion detection system may be used.

According to embodiments of the present disclosure, since an attack detection algorithm can be performed differently according to a load rate of a CPU, it is possible to prevent the degradation of a function or stop of operation of an intrusion detection system.

In addition, according to embodiments of the present disclosure, specifications, a state, and/or an environment of a vehicle may be considered in determining whether the attack detection algorithm is performed.

Although some example embodiments are described above, these are only illustrative and do not limit the present disclosure/Those having ordinary skill in the art to which the present disclosure pertains should recognize that various modifications and applications not described above are possible without departing from the essential characteristics of the present disclosure. For example, each component specifically shown in the embodiments may be implemented by modification. In addition, differences related to these modifications and applications should be construed as being included in the scope of the present disclosure defined in the appended claims.

What is claimed is:

1. A method of operating an apparatus including an intrusion detection system in a controller area network (CAN) of a vehicle, the method comprising:
receiving CAN messages transmitted through the CAN for a determined time, wherein the determined time is a time required for receiving a predetermined number of CAN messages having a shortest message period among multiple message periods supported by the CAN;
determining a processor load rate of one or more processors of the apparatus while receiving the CAN messages;
comparing the processor load rate with a processor load rate threshold value of an attack detection algorithm; and
performing the attack detection algorithm based on determining that the processor load rate threshold value of the attack detection algorithm is greater than the processor load rate.

2. The method of claim 1, wherein:
the one or more processors include a plurality of processors; and
the processor load rate is an average of load rates of the plurality of processors.

3. The method of claim 1, wherein the processor load rate threshold value is determined based on at least one of a function, specifications, a driving state, or a communication environment of the vehicle.

4. The method of claim 1, wherein the processor load rate threshold value is determined as a fraction of
$${\sum }_{n = 1}^{m} {l}_{n} ,$$
wherein n denotes a processor index, m denotes a number of processors among the one or more processors, and lₙ denotes an average load rate of a processor n measured for a certain amount of time.

5. The method of claim 1, wherein the processor load rate threshold value is obtained by measuring an average load rate of the one or more processors in consideration of at least one of a driving state of the vehicle or a communication environment of the vehicle.

6. The method of claim 1, further comprising, based on determining that the processor load rate is less than or equal to the processor load rate threshold value of the attack detection algorithm, not performing the attack detection algorithm.

7. An apparatus including an intrusion detection system in a controller area network (CAN) of a vehicle, the apparatus comprising:
a storage unit;
a communication unit configured to support CAN communication; and
one or more processors configured to
receive CAN messages transmitted through the CAN for a determined time, wherein the determined time is a time required for receiving a predetermined number of messages having a shortest message period among multiple message periods supported by the CAN,
determine a processor load rate of the one or more processors while receiving the CAN messages,
compare the processor load rate with a processor load rate threshold value of an attack detection algorithm, and
perform the attack detection algorithm based on determining that the processor load rate threshold value of the attack detection algorithm is greater than the processor load rate.

8. The apparatus of claim 7, wherein:
the one or more processors include a plurality of processors; and
the processor load rate is an average of load rates of the plurality of processors.

9. The apparatus of claim 7, wherein the processor load rate threshold value is determined based on at least one of a function, specifications, a driving state, or a communication environment of the vehicle.

10. The apparatus of claim 7, wherein the processor load rate threshold value is determined as a fraction of
$${\sum }_{n = 1}^{m} {l}_{n} ,$$
wherein n denotes a processor index, m denotes a number of processors in the one or more processors, and lₙ denotes an average load rate of a processor n measured for a certain amount of time.

11. The apparatus of claim 7, wherein the processor load rate threshold value is obtained by measuring an average load rate of the one or more processors in consideration of at least one of a driving state of the vehicle or a communication environment of the vehicle.

12. The apparatus of claim 7, wherein the one or more processors are configured to, based on determining that the processor load rate is less than or equal to the processor load rate threshold value of the attack detection algorithm, not perform the attack detection algorithm.
